(19) United States
(12) Patent Application Publication
(10) Pub. No.: US 2013/0150205 A1
(43) Pub. Date: Jun. 13, 2013

(54) APPARATUS FOR ELIMINATING BACKLASH IN A PLANETARY GEAR SET

(71) Applicants: Jinn-Fa WU, Taichung City (TW); Hsi-Hung HSIAO, Taichung City (TW); Chin-Mou HSU, Taichung City (TW); Ching-Yuan LIN, Taichung City (TW)

(72) Inventors: Jinn-Fa WU, Taichung City (TW); Hsi-Hung HSIAO, Taichung City (TW); Chin-Mou HSU, Taichung City (TW); Ching-Yuan LIN, Taichung City (TW)

(73) Assignee: INDUSTRIAL TECHNOLOGY RESEARCH INSTITUTE, Hsin-Chu (TW)

(21) Appl. No.: 13/552,339

(22) Filed: Jul. 18, 2012

(30) Foreign Application Priority Data
Dec. 13, 2011 (TW) 100146001

(51) Int. Cl. F16H 57/12

(52) U.S. Cl. 475/347; 475/346

(57) ABSTRACT

An apparatus for eliminating backlash is disclosed, which is installed between a first planet gear and a second planet gear in a planetary gear set to be used for generating a preload elastic force in a direction perpendicular to the direction of an input torque of the planetary gear set so as to eliminate a two-way backlash of the planetary gear set.

### TECHNICAL FIELD

The present disclosure relates to an apparatus for eliminating backlash in a planetary gear set, and more particularly, to a backlash eliminating apparatus capable of generating a preload elastic force for eliminating a two-way backlash in a planetary gear set.

### TECHNICAL BACKGROUND

With the improvement of gear transmission, the planetary gear set is becoming more and more popular as it is advantaged in its compactness, light weight outstanding power transmission efficiency and greater load ability. Thus, there are increasing gear transmission mechanism adopting planetary gear set for achieving a compact design with higher power transmission efficiency.

Basically, a planetray gear set is a gear system consisting of one or more planet gears, revolving about a sun gear, while enabling the planet gears to mesh with an outer ring gear. However, there are generally backlashes being generated in all types of planetary gear set due to manufacture error, poor assembly quality and certain unavoidable circumtances. Since backlashes, which are clearances between mating components, could potentially cause rotation vibration, noise and positioning error in gear trains, therefore, it is in need of a method and apparatus for effectively eliminating backlash.

### TECHNICAL SUMMARY

The object of the present disclosure is to provide a backlash eliminating apparatus capable of generating a preload elastic force for effectively eliminating a bi-directional backlash in a planetary gear set.

To achieve the above object, the present disclosure provides a backlash eliminating apparatus, adapted for eliminating backlash in a planetary gear set whereas the planetary gear set is comprised of a ring gear, a sun gear and a plurality of planet gear modules, and each planet gear module is configured with a first planet gear and a second planet gear in a manner that the first and the second planet gears are arranged stacking on top of each other while allowing the second planet gear to mesh with the ring gear, and also allowing the sun gear to be arranged at a position surrounding by the plural first planet gears and simultaneously being engaged with the same, the backlash eliminating apparatus comprising:
at least one pull coupler, each disposed at a position between the first planet gear and the second planet gear of one corresponding planet gear module; and
at least one push coupler, each disposed at a position between the first planet gear and the second planet gear of one corresponding planet gear module where there is no pull coupler being disposed thereat.

In an embodiment, the present disclosure provides a backlash eliminating apparatus comprises:
a tube, having a groove formed on the circumferential wall thereof.

In another embodiment, the present disclosure further provides a backlash eliminating apparatus, adapted for eliminating backlash in a planet gear module whereas the planet gear module is comprised of two planet gears, the backlash eliminating apparatus comprising:
a tube, having a groove formed on the circumferential wall thereof and integrally formed with one planet gear selected from the two planet gears while allowing the tube to coupled to another planet gear by an end thereof.

Moreover, In another embodiment, the present disclosure further provides a backlash eliminating apparatus, adapted for eliminating backlash in a planet gear module, the backlash eliminating apparatus comprising:
a tube, integrally formed with the planet gear module while having a groove formed on the circumferential wall thereof.

To sum up, the backlash eliminating apparatus of the present disclosure is featuring in that: the pull coupler is provided for producing a pre-load tension and the push coupler is provided for producing a pre-load trust that are enabled to work cooperatively as a pro-load elastic force, i.e. the backlash eliminating apparatus that is formed as a tube is used for generating a pre-load elastic force in a direction perpendicular to the direction of an input torque of the planetary gear set so as to eliminate a two-way backlash of the planetary gear set.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a three-dimensional diagram showing a planetary gear set of the present disclosure.

FIG. 2 is an exploded diagram showing a planetary gear set and a backlash eliminating apparatus of the present disclosure.

FIG. 3 is a cross-sectional view of a planetary gear set and a backlash eliminating apparatus according to a first embodiment of the present disclosure.

FIG. 4 is a three-dimensional view of a backlash eliminating apparatus according to an embodiment of the present disclosure.

FIG. 5 is a side view of a backlash eliminating apparatus according to an embodiment of the present disclosure.

FIG. 6 is a schematic diagram illustrating the operation of a backlash eliminating apparatus in a planetary gear set according to an embodiment of the present disclosure.

FIG. 7 is a cross-sectional view of a planetary gear set and a backlash eliminating apparatus according to a second embodiment of the present disclosure.

FIG. 8 is a partial cross-sectional view of a planetary gear set and a backlash eliminating apparatus according to a third embodiment of the present disclosure.

FIG. 9 is another partial cross-sectional view of a planetary gear set and a backlash eliminating apparatus according to the third embodiment of the present disclosure.

FIG. 10 is a partial cross-sectional view of a planetary gear set and a backlash eliminating apparatus according to a fourth embodiment of the present disclosure.

FIG. 11 is another partial cross-sectional view of a planetary gear set and a backlash eliminating apparatus according to the fourth embodiment of the present disclosure.

### DESCRIPTION OF THE EXEMPLARY EMBODIMENTS

For your esteemed members of reviewing committee to further understand and recognize the fulfilled functions and structural characteristics of the disclosure, several exemplary embodiments cooperating with detailed description are presented as the follows.

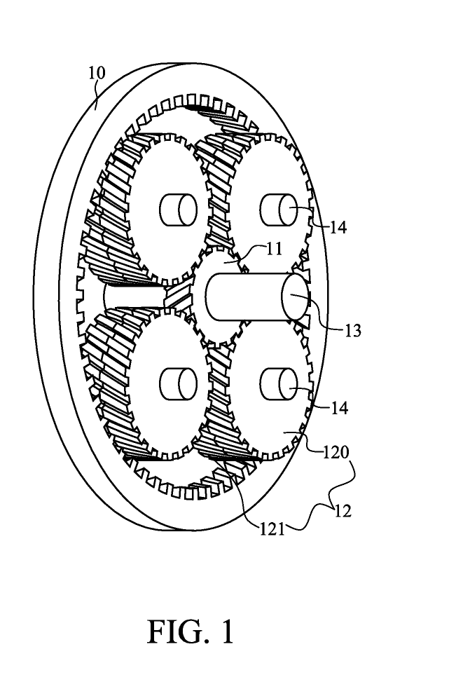

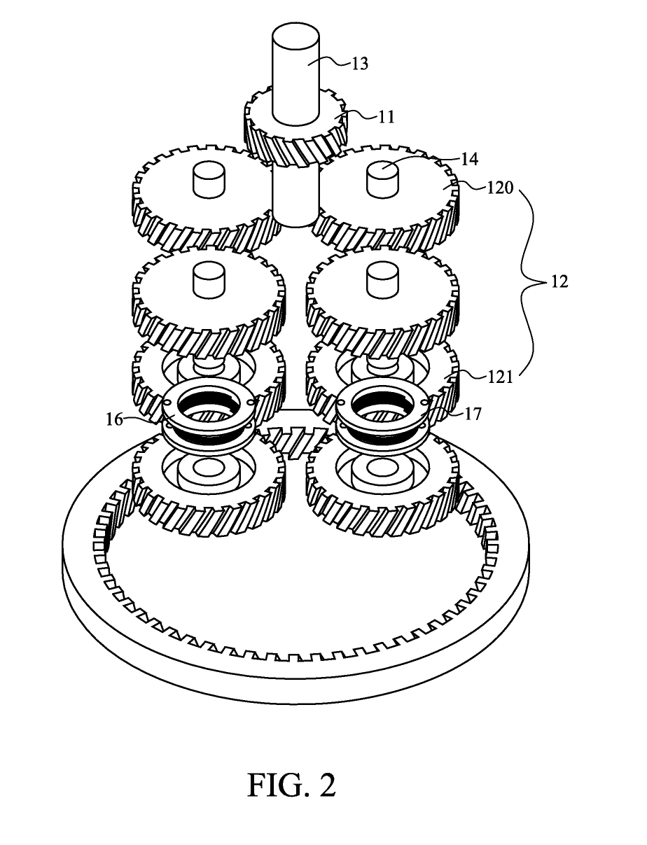

As shown in FIG. 1 and FIG. 2, the backlash eliminating apparatus is adapted for eliminating backlash in a planetary gear set, whereas the planetary gear set is comprised of a ring gear 10, a sun gear 11 and a plurality of planet gear modules 12, a sun gear shaft 13 and a plurality of planet gear shafts 14.

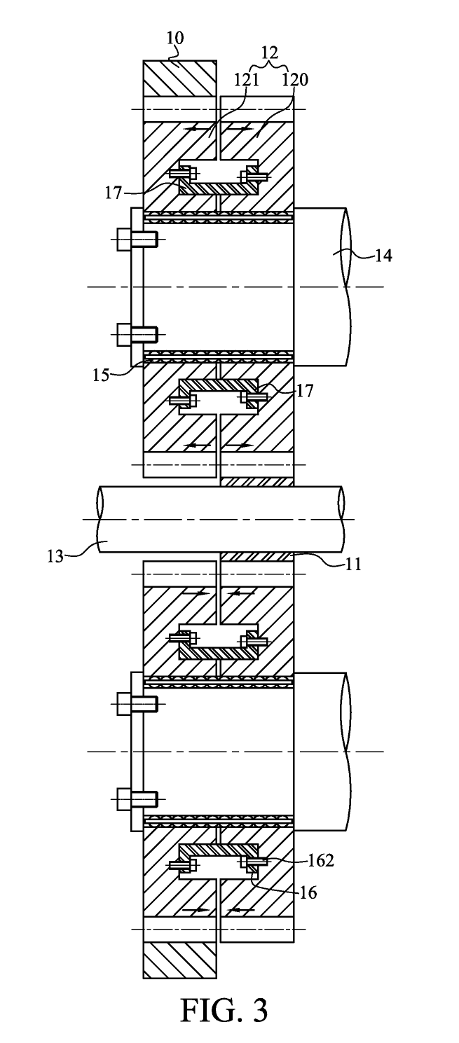

The sun gear 11 and the plural planet gear modules 12 are arranged inside the ring gear 10, and each of the planet gear modules 12 is configured with a first planet gear 120 and a second planet gear 121 in a manner that the first and the second planet gears 120, 121 are arranged stacking on top of each other while allowing the second planet gear 121 to mesh with the ring gear 10, and also allowing the sun gear 10 to be arranged at a position surrounding by the plural first planet gears 120 and simultaneously being engaged with the same. In addition, the sun gear shaft 13 is coupled to the sun gear 11, and the plural planet gear modules 12 are arranged coupling to their respective planet gear shafts 14. As shown in FIG. 3, there is further a ball bushing 15 arranged at a position between each planet gear module 12 and its corresponding planet gear shaft 14.

In an embodiment of the present disclosure, the teeth of the ring gear 10, the sun gear 11, the first planet gears 120 and the second planet gears 121 are helical teeth.

As shown in FIG. 2, the backlash eliminating apparatus of the present disclosure comprises: at least one pull coupler 16 and at least one push coupler 17, in which each pull coupler 16 is disposed at a position between the first planet gear 120 and the second planet gear 121 of one corresponding planet gear module 12; and each push coupler 17 is disposed at a position between the first planet gear 120 and the second planet gear 121 of one corresponding planet gear module 12 where there is no pull coupler 16 being disposed thereat.

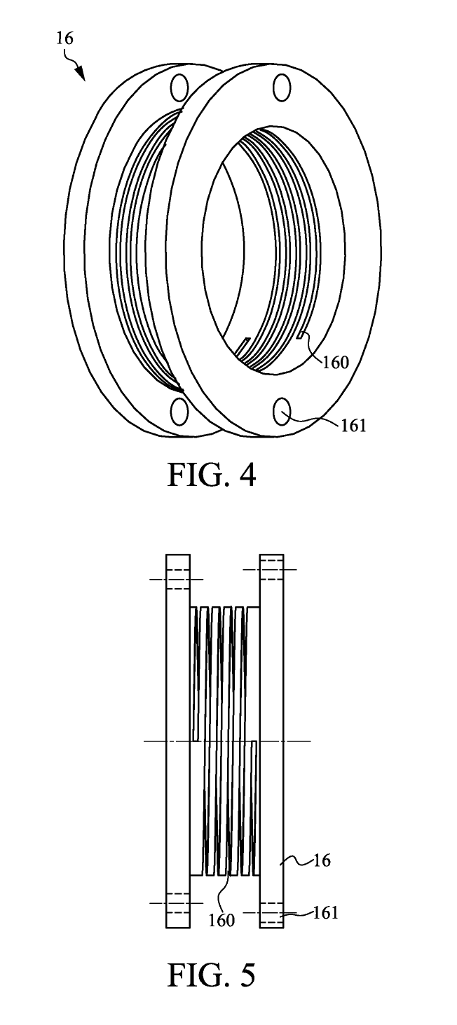

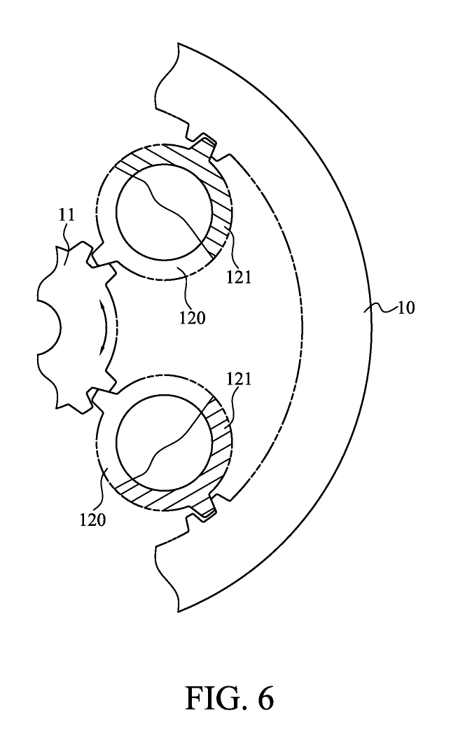

As shown in FIG. 4 and FIG. 5, each pull coupler 16 is formed as a flexible tube having a groove 160 formed on the circumferential wall thereof. In an embodiment of the present disclosure, the groove 160 is formed spirally extending on the circumferential wall of the pull coupler 16 all the way from one end to another. In this embodiment, there are a plurality of holes 161 formed on the two ends of the pull coupler 16, and correspondingly there are a plurality of fixing elements 162 arranged piercing through the plural holes 161 so as to couple simultaneously to a side of the first planet gear 120 that is facing toward the second planet gear 121, and a side of the second planet gear 121 that is facing toward the first planet gear 120, resulting that the pull coupler 16 is fixedly secured at a position between the first planet gear 120 and the second planet gear 121.

On the other hand, the push coupler 17 is disposed at a position between the first planet gear 120 and the second planet gear 121 of one corresponding planet gear module 12 where there is no pull coupler 16 being disposed thereat. Accordingly, the pull coupler 16 and the push coupler 17 are basically the same device in structure, but are disposed at different locations for allowing the pull coupler 16 to produce an axial tension and the push coupler 17 to produce an axial trust.

As shown in FIG. 2 and FIG. 3, the first planet gear 120 and the second planet gear 121 of each planet gear module 12 are arranged stacking on top of each other so as to form a two-layer structure. Moreover, the pull coupler 16 is provided for producing an axial pre-load tension and the push coupler 17 is provided for producing an axial pre-load trust that are enabled to work cooperatively as a pro-load elastic force upon the engagement between the sun gear 11 and the planet gear module 12 as well the engagement between the planet gear module 12 and the ring gear 10 so as to eliminate a two-way backlash of the planetary gear set.

Operationally, the pre-load elastic force will force the rotating first planet gear 120 to mesh and engage tightly with the sun gear 11 while also force the rotating second planet gear 121 to mesh and engage tightly with the ring gear 10, by that the two-way backlash in the planetary gear set can be minimized, or even eliminated. That is, by the pre-load tension and the pre-load trust, the operating planet gear module 12 can be forced to mesh and engage tightly with the ring gear 10 and the sun gear 11 in respective for minimizing or even eliminating backlashes.

In an embodiment, each of the at least one pull coupler 16 and the at least one push coupler 17 is formed as a tube having a groove 160 formed on the circumferential wall thereof, whereas the tube is made to be flexible by the design of the groove 160 so as to be able to produce the aforesaid pre-load elastic force in an axial direction while allowing the tube to transmit torque.

As shown in FIG. 3, the bal bushing 15 that is arranged at a position between each planet gear module 12 and its corresponding planet gear shaft 14, is provided for allowing the first planet gear 120 and the second planet gear 121 to slide and rotate against the corresponding planet gear shaft 14.

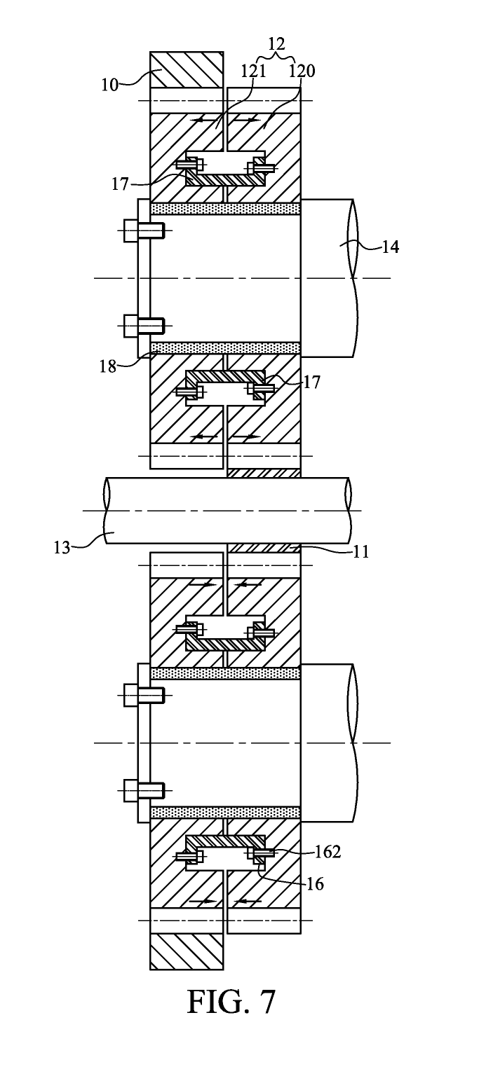

Please refer to FIG. 7, which is a cross-sectional view of a planetary gear set and a backlash eliminating apparatus according to a second embodiment of the present disclosure. In this second embodiment, all the components used are basically the same as those disclosed in the first embodiment, but is different in that: the ball bushing in the first embodiment is replaced by a lubricating unit 18, which is arranged filling the gap between the planet gear shaft 14 and the planet gear module 12 for lubrication and functioning as the ball bushing.

Similarly, in this second embodiment, the pull coupler 16 and the push coupler 17 is formed as a tube having a groove 160 formed on the circumferential wall thereof, whereas the tube is made to be flexible by the design of the groove 160 so as to be able to produce a pre-load elastic force in an axial direction, i.e. a pro-load tension for the pull coupler 16 for forcing the rotating planet gear module 12 to mesh and engage tightly with the sun gear 11, and a pre-load trust for the push coupler 17 for forcing the rotating planet gear module 12 to mesh and engage tightly with the ring gear 10, by that the two-way backlash in the planetary gear set can be minimized, or even eliminated. Moreover, the direction of the preload elastic force is perpendicular to the direction of an input torque of the planetary gear set.

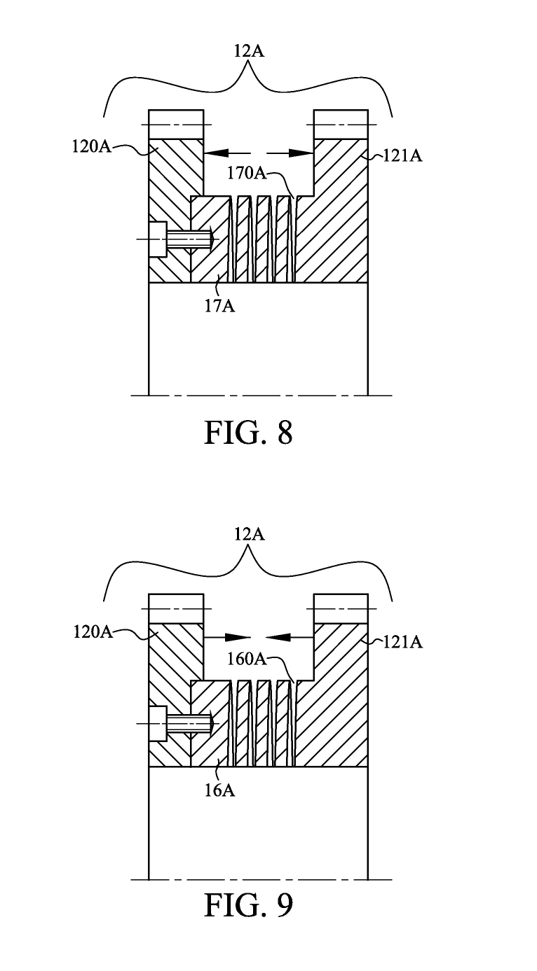

Please refer to FIG. 8 and FIG. 9, which show a planetary gear set and a backlash eliminating apparatus according to a third embodiment of the present disclosure. In this third embodiment, the push coupler 17A is integrally formed with the second planet gear 121A while allowing the same to couple to the first planet gear 120A by an end thereof, as shown in FIG. 8; and similarly the pull coupler 16A is integrally formed with the second planet gear 121A while allowing the same to couple to the first planet gear 120A by an end thereof, as shown in FIG. 9. Moreover, in this third embodiment, each pull coupler 16A and push coupler 17A is formed as a flexible tube having a groove 160A, 170A formed on the circumferential wall thereof in a manner that it is formed spirally extending on the circumferential wall of the tube all the way from one end to another. It is noted that all the other components used in this third embodiment are basically the same as those disclosed in the previous embodiments, and thus will not be described further herein.

It is noted that instead of enabling the push coupler 17A to be integrally formed with the second planet gear 121A, the push coupler 17A can be integrally formed with the first planet gear 120A and the pull coupler 16A is coupled to the second planet gear 121A by an end thereof, that the aforesaid structure is a mirror structure to that disclosed in FIG. 8, and thus no diagram relating to this mirror structure will be provided herein.

Moreover, in this third embodiment, the planet gear module can be composed of two planet gears, in which one of the two planet gear is integrally formed with a tube while allowing the tube to couple with another planet gear by an end thereof. It is noted that the tube is substantially the pull coupler or the push coupler.

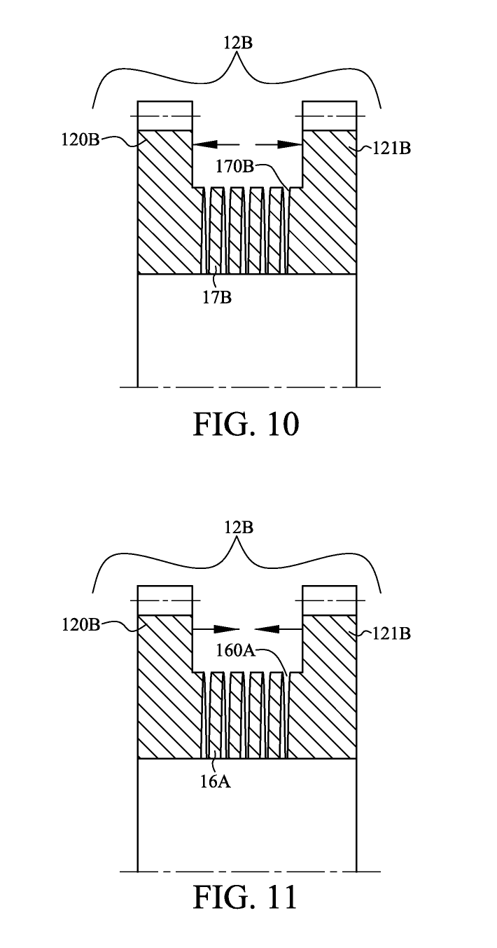

Please refer to FIG. 10 and FIG. 10, which show a planetary gear set and a backlash eliminating apparatus according to a fourth embodiment of the present disclosure. In this fourth embodiment, the push coupler 17B is integrally formed with the planet gear module 12B while allowing the same to be positioned between the first planet gear 120B and the second planet gear 121B, as shown in FIG. 10; and similarly the pull coupler 16B is integrally formed with the planet gear module 12B while allowing the same to be positioned between the first planet gear 120B and the second planet gear 121B, as shown in FIG. 11. Moreover, in this fourth embodiment, each pull coupler 16B and push coupler 17B is formed as a flexible tube having a groove 160B, 170B formed on the circumferential wall thereof in a manner that it is formed spirally extending on the circumferential wall of the tube all the way from one end to another. It is noted that all the other components used in this fourth embodiment are basically the same as those disclosed in the previous embodiments, and thus will not be described further herein.

Moreover, in this fourth embodiment, the tube that is integrally formed with the planet gear module can substantially be the pull coupler or the push coupler, and the teeth of the planet gear module are helical teeth.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. A backlash eliminating apparatus, adapted for eliminating backlash in a planetary gear set whereas the planetary gear set is comprised of a ring gear, a sun gear and a plurality of planet gear modules, and each planet gear module is configured with a first planet gear and a second planet gear in a manner that the first and the second planet gears are arranged stacking on top of each other while allowing the second planet gear to mesh with the ring gear, and also allowing the sun gear to be arranged at a position surrounding by the plural first planet gears and simultaneously being engaged with the same, the backlash eliminating apparatus comprising:
at least one pull coupler, each disposed at a position between the first planet gear and the second planet gear of one corresponding planet gear module; and
at least one push coupler, each disposed at a position between the first planet gear and the second planet gear of one corresponding planet gear module where there is no pull coupler being disposed thereat.

2. The backlash eliminating apparatus of claim 1, wherein each of the at least one pull coupler and the at least one push coupler is formed as a tube having a groove formed on the circumferential wall thereof.

3. The backlash eliminating apparatus of claim 2, wherein the tube is flexible, and the groove is formed spirally extending on the circumferential wall of the tube all the way from one end to another.

4. The backlash eliminating apparatus of claim 1, wherein the teeth of the ring gear, the sun gear, the first planet gears and the second planet gears are helical teeth.

5. The backlash eliminating apparatus of claim 1, wherein the sun gear is coupled to a sun gear shaft, and the plural planet gear modules are arranged coupling to their respective planet gear shafts.

6. The backlash eliminating apparatus of claim 5, wherein a device selected from the group consisting of a ball bushing and a lubricating unit is used and disposed at a position between each of the plural planet gear modules and one planet gear shaft corresponding thereto.

7. The backlash eliminating apparatus of claim 1, wherein the pull coupler is integrally formed with the second planet gear.

8. The backlash eliminating apparatus of claim 1, wherein the push coupler is integrally formed with the second planet gear.

9. The backlash eliminating apparatus of claim 1, wherein the pull coupler is integrally formed with the first planet gear.

10. The backlash eliminating apparatus of claim 1, wherein the push coupler is integrally formed with the second planet gear.

11. The backlash eliminating apparatus of claim 1, wherein the planet gear module is integrally formed with the pull coupler.

12. The backlash eliminating apparatus of claim 1, wherein the planet gear module is integrally formed with the push coupler.

13. A backlash eliminating apparatus, comprising:
a tube, having a groove formed on the circumferential wall thereof.

14. The backlash eliminating apparatus of claim 13, wherein the tube is flexible, and the groove is formed spirally extending on the circumferential wall of the tube all the way from one end to another.

15. A backlash eliminating apparatus, adapted for eliminating backlash in a planet gear module, the backlash eliminating apparatus comprising:
having a groove formed on the circumferential wall thereof and integrally formed with one planet gear selected from the two planet gears while allowing the tube to coupled to another planet gear by an end thereof.

16. The backlash eliminating apparatus of claim 15, wherein the tube is flexible, and the groove is formed spirally extending on the circumferential wall of the tube all the way from one end to another.

17. The backlash eliminating apparatus of claim 15, wherein the teeth of the planet gears are helical teeth.

18. A backlash eliminating apparatus, adapted for eliminating backlash in a planet gear module, the backlash eliminating apparatus comprising:
a tube, integrally formed with the planet gear module while having a groove formed on the circumferential wall thereof.

19. The backlash eliminating apparatus of claim 18, wherein the tube is flexible, and the groove is formed spirally extending on the circumferential wall of the tube all the way from one end to another.

20. The backlash eliminating apparatus of claim 18, wherein the teeth of the planet gear module are helical teeth.
